(19) United States
(12) Patent Application Publication
(10) Pub. No.: US 2014/0067214 A1
(43) Pub. Date: Mar. 6, 2014

(54) MOTOR VEHICLE WITH AN ACTUATOR-OPERATED CLUTCH

(71) Applicant: GM GLOBAL TECHNOLOGY OPERATIONS LLC, Detroit, MI (US)

(72) Inventors: Christian RUEBSAM, Bodenheim (DE); Michael SELINGER, Mainz (DE)

(73) Assignee: GM GLOBAL TECHNOLOGY OPERATIONS LLC, Detroit, MI (US)

(21) Appl. No.: 13/956,597

(22) Filed: Aug. 1, 2013

(30) Foreign Application Priority Data
Aug. 1, 2012 (DE) 10 2012 015 291.4

(51) Int. Cl. F16D 48/06

(52) U.S. Cl. CPC F16D 48/064
USPC 701/67

(57) ABSTRACT

A motor vehicle, in particular a passenger car, is provided with an internal combustion engine, a drive wheel arrangement that can be connected to the former, a clutch for the optional connecting and disconnecting of internal combustion engine and drive wheel arrangement, an actuator for actuating set clutch, and a controller for controlling set actuator, The set controller comprises a comparator for comparing a set quantity and an actual quantity and an actuator that is equipped in order to in particular partly close or open the clutch based on this comparison of set quantity and actual quantity, and to a method for the automatic actuating of the clutch.

### CROSS-REFERENCE TO RELATED APPLICATION

This application claims priority to German Patent Application No. DE 10 2012 015 291.4, filed Aug. 1, 2012, which is incorporated herein by reference in its entirety.

### TECHNICAL FIELD

This technical field relates to a motor vehicle, in particular a passenger car, with an actuator-operated clutch, a method for automatically operating this clutch and a computer program product for carrying out this method.

### BACKGROUND

From DE 10 2008 029 453 A1 a so-called sailing mode is known on the one hand in motor vehicles that can be established by engaging the position “N” on the selector lever of an automatic vehicle or by pressing the clutch or engaging the neutral gear in the case of a manual shifter, so that the motor vehicle during rolling is not braked through the drag moment of the engine, and on the other hand a so-called coasting mode is known, in which the motor is connected to the drive train. Through a so-called deceleration fuel cutoff (DFCO), the fuel supply to the engine can be interrupted in a coasting mode and thus its consumption minimized.

In certain driving situations it can be more favorable to utilize the deceleration fuel cutoff, for example when travelling steep downhill sections, where the braking action of the engine which is not supplied with fuel can be additionally advantageous. In other driving situations, the sailing mode can be more favorable in overall energy terms, for example when travelling on slight downhill sections, where the loss of kinetic energy through the drag moment of the engine can exceed the fuel saving of the coasting mode. DE 10 2008 029 453 A1 proposes a method for adjusting the sailing mode in a motor vehicle, where the driver can switch into the sailing mode through a haptically perceptible accelerator or brake pedal position or actuating a cruise control. Equally, a sensor device can be provided which detects that the current power or speed requirement can also be fulfilled without engine, and then automatically switches into the sailing mode.

In view of the foregoing, at least one object is to improve the operation of a motor vehicle. In addition, other objects, desirable features and characteristics will become apparent from the subsequent summary and detailed description, and the appended claims, taken in conjunction with the accompanying drawings and this background.

### SUMMARY

According to an embodiment, a motor vehicle, in particular a passenger car, is provided that comprises an internal combustion engine, in particular a spark-ignition or diesel engine, a drive wheel arrangement that can be connected to said internal combustion engine, which drive wheel arrangement can comprise in particular a driven front axle and/or rear axle, and a clutch for the optional connecting and disconnecting of internal combustion engine and drive wheel arrangement. A manually, semi or fully automatically shiftable transmission can be arranged on the internal combustion engine and/or drive wheel arrangement side of the clutch in a drive train between internal combustion engine and drive wheel arrangement.

For actuating this clutch, an actuator and a controller for controlling this actuator is provided according to an embodiment. In a further development, the actuator can electromotorically, electromagnetically, hydraulically and/or pneumatically actuate the clutch and to this end comprise in particular one or a plurality of electric motors, electromagnets and/or hydraulic and/or pneumatic delivery means, in particular pumps, pressure reservoirs and/or control elements, in particular valves. According to a further embodiment, the control element is signal-connected to the actuator electrically, in particular via a bus core in a cable-free manner. Thus, a vehicle according to an embodiment comprises a so-called clutch-by-wire clutch, which is not mechanically coupled or connected to a clutch actuator, in particular a clutch and/or foot pedal. In this way, the clutch, in particular in addition to the manual clutch actuations by the driver, the clutch can (also) be automatically actuated through the controller, such an automatic clutch automation can be preferentially be subordinately prioritized compared with a manual actuation: if the driver actuates a clutch actuator, the controller converts this into a corresponding clutch actuation by the actuator, independently of a possible automatic clutch actuation, which with respect to this can be deferred or ignored or postponed.

According to an embodiment, the controller comprises a comparator for comparing a set quantity and an actual quantity and an actuator, which is equipped based on this comparison of set and actual quantity to close or open the clutch, in particular partly. According to an embodiment, a method is provided for the automatic actuating of the clutch comprises comparison of a set quantity and an actual quantity, in particular through the comparator, and of the in particular partial closing or opening of the clutch based on this comparison of set quantity and actual quantity, in particular through the actuator.

In particular a control, comparator and/or actuator is formed as hardware and/or software, in particular comprise an in particular digital processing, in particular microprocessor unit (CPU) or microprocessor part unit and/or one or a plurality of programs or program modules that is preferentially data or signal-connected to a storage system and/or bus system. The CPU is configured to execute commands that are implemented as a program stored in a storage system, to register input signals from a data bus and/or output signals to a data bus. A storage system can comprise one or a plurality of, in particular different, storage media, in particular optical, magnetic, solid body and/or other non-volatile media. The program can be of such a nature that it is capable of embodying or executing the method described here, so that the CPU can execute the steps of such methods and thereby control in particular the actuator. Accordingly, the following embodiments can equally apply to the device and/or method aspect.

According to an embodiment, the clutch is optionally closed or open through the actuator. According to an embodiment, the controller can thus automatically switch into a sailing mode, in which the clutch is completely open or internal combustion engine and drive wheel arrangement are mechanically completely disconnected from one another and from said sailing mode back again into a coasting mode, in which the clutch is in particular fully closed or internal combustion engine and drive wheel arrangement are mechanically connected or coupled to one another in particular, at least substantially without slip.

In this way, it is possible in an embodiment, in particular also with a manually actuatable clutch-by-wire clutch to automatically switch into the sailing and the coasting mode whichever is more advantageous. In particular, it is possible to switch from a sailing mode automatically into a coasting mode with deceleration fuel cutoff or interruption of the fuel supply if this is more favorable, for example on a steep downhill section.

According to an embodiment, the clutch is partly closed or open through the actuator. A partly closed or opened clutch means in particular a clutch or a clutch state in which a driving force in comparison with a completely closed clutch is transmitted only at a lesser part or percentage, in particular at a maximum of approximately 90%, preferentially at a maximum of approximately 75%, in particular at a maximum of approximately 50% and preferentially at a maximum of approximately 45%, and/or at least at approximately 10%, between internal combustion engine and drive arrangement, where for the more compact representation, anti-parallel force pairs, i.e., torques, in this case are to mean also forces in a generalized manner. A partly closed or open clutch in the sense can also be described as a “slipping” clutch and for example be formed through a pressure or friction force between clutch elements, in particular linings that are reduced compared with a completely closed clutch. Equally, a partly closed or open clutch can, for example, be formed through a torque convertor with disconnected convertor lock-up clutch.

In particular, at least substantially, the clutch can be continuously or discretizisedly partly closed or opened, for example in predetermined steps, where between completely opened and completely closed clutch in a further development, at least two, in particular at least five steps can be provided. In an embodiment, a closing time of the clutch can be varied in particular based on a family of characteristics, on the basis of a driving situation, in particular vehicle speed, transmission stage or of a gear, an accelerator pedal position and/or a rotational speed of the internal combustion engine and/or of the drive wheel arrangement.

By partly opening or closing the clutch, a hybrid mixture of sailing and deceleration mode can be realized in an advantageous manner. According to an embodiment, the internal combustion engine in sailing mode is operated at idle rotational speed and consumes fuel. In the deceleration mode, the fuel supply, in a further development, can be at least substantially interrupted so that the fuel consumption is minimized.

The so-called drag moment of an internal combustion engine, i.e., the resistance force with that it opposes co-rotation through the drive wheel arrangement, which is rotated by force, for example, through rolling down a steep incline or rolling out under gravity, depends among other things on the imposed rotational speed of the internal combustion engine. Through a slipping clutch, the drag moment of the internal combustion engine can be adapted to the requirements. For example, by increasingly closing the clutch, an increasing drag moment can be imposed in order to keep the speed of the vehicle while rolling down with increasing incline at least substantially constant. Conversely, by increasingly opening the clutch, a decreasing drag moment can be imposed in order to keep the speed of a vehicle at least substantially constant during a rolling down of the vehicle with decreasing inclination. This adaptation of the drag moment, which is imposed in deceleration mode, can advantageously take place as far as into the sailing mode, in which the drag moment, at least substantially, is completely absent.

According to an embodiment, the clutch is actuated based on a comparison of kinematic set and actual quantities. In particular, an actual vehicle speed can be determined, preferentially from one or a plurality of wheel rotational speeds. Additionally or alternatively, actual vehicle acceleration can be determined, preferentially through time differentiation of a determined actual vehicle speed and/or by means of at least one acceleration sensor. A set vehicle speed and/or acceleration can be predetermined in particular through a cruise control or determined from an actuation of a pedal arrangement, in particular an actuation of an accelerator and/or of a brake pedal, wherein for the more compact representation any manually actuatable input for actuating a vehicle brake or the adjusting of a power output of the internal combustion engine, in particular suitably movable foot and hand pedals or levers are described as brake or foot pedal in a generalizing manner.

In an embodiment, it is possible to switch into the sailing mode or the clutch be automatically opened completely when a kinematic set quantity undershoots or exceeds a kinematic actual quantity be a predetermined, in particular variably predeterminable limit value, the vehicle, for example, becomes slower or travels as predetermined, or a difference between a kinematic set and actual quantity if the amount exceeds or undershoots a predetermined, in particular variably predeterminable limit value, the vehicle, for example, travels with at least substantially constant speed. Additionally or alternatively, the clutch can be closed when a kinematic set quantity exceeds or undershoots a kinematic actual quantity by a predetermined, in particular variably predeterminable limit value, the vehicle, for example, becomes or travels faster than predetermined, or a difference between a kinematic set and actual quantity in the amount undershoots or exceeds a predetermined, in particular variably predeterminable limit value, the vehicle speed, for example, changes beyond a limit value. Described above, the clutch in particular can be completely closed when a kinematic set quantity exceeds or undershoots a kinematic actual quantity by a predetermined limit value or a difference between a kinematic set and actual quantity in the amount undershoots or exceeds a predetermined limit value. Equally, the clutch can be increasingly opened or closed corresponding to a difference between a kinematic set and actual quantity, for example, proportionally to this difference or its amount.

In an embodiment, it is possible to switch into the sailing mode or the clutch be automatically completely opened or switched into the deceleration mode or the clutch automatically completely closed when a thermal set quantity exceeds a thermal actual quantity by a predetermined, in particular variably predeterminable limit value, in particular the temperature of the clutch or its time gradient exceeds a limit value. In particular, when travelling with a slipping clutch for an extended period of time, said clutch can overheat. In order to avoid this, it can be completely opened for cooling in the case of corresponding temperature development or completely closed in order to reduce the slip and thus the designation heat.

In an embodiment, the temperature of the clutch can be directly registered for example via a senor. Equally, it can also be estimated for example by way of an energy input. Generally, in an embodiment, the clutch can be automatically completely or partly opened or closed when a dynamic set quantity undershoots or exceeds a dynamic actual quantity by a predetermined, in particular variably predeterminable limit value. A dynamic quantity in the sense can comprise, in particular be a driving force and/or driving power. For example, the clutch can be (increasingly) closed in order to impose an (increasing) drag moment when an actual driving force and/or driving power exceeds a set driving force or driving power, in order to offset or at least reduce this difference. Additionally or alternatively, the clutch can be automatically completely opened or closed when the driving force or driving power integrated over a period of time in the amount exceeds a set value or limit value, since from this an excessive energy input into the clutch and thus a corresponding heat development can be estimated.

The choice between sailing, deceleration and if applicable a hybrid mixture of sailing and deceleration mode can depend in particular on a future travelling route of the vehicle. Thus, when travelling down an incline section with subsequent stop it can be practical to switch into the deceleration mode in order to utilize the drag moment and, upon deceleration fuel cutoff, to minimize the fuel consumption. If the vehicle, by contrast, is to continue to roll having travelled down an inclined section it can be practical to switch into the sailing mode in order to conserve its kinetic energy.

For this reason, an estimator or an estimating of an in particular future kinematic quantity, in particular vehicle speed and/or vehicle acceleration is provided in a further development. The clutch based on this estimation is in particular partly closed or opened. Estimating can in particular be carried out with a route planning, navigation, environment recognition system or the like. Thus, it is possible, for example, to switch into the deceleration mode when an environment recognition system recognizes a stop sign, a red traffic light or the like and in this way a future or imminent stop of the vehicle can be estimated, or into the sailing mode, when based on a navigation system and/or an environment recognition a free rolling after an inclined section can be estimated.

In an embodiment, the motor vehicle comprises a pedal arrangement with an accelerator pedal and brake pedal, preferentially also a clutch pedal. The clutch can be opened or closed based on an actuation of this pedal arrangement. It can be provided, in particular, that switching into the sailing mode or the complete opening of the clutch is only performed when no pedal of the pedal arrangement is manually actuated and/or that switching into the deceleration mode or partly or completely closing the clutch is only performed when any pedal of the pedal arrangement is manually actuated.

In particular, in deceleration mode or with completely or partly closed clutch, a deceleration fuel cutoff (DFCO) or interruption of a fuel supply to the internal combustion engine can be provided. Additionally or alternatively, an interruption of the fuel supply can be provided in the sailing mode or with completely opened clutch. In a further embodiment, vehicle units, in particular a brake and/or steering assistance can then be supplied from a battery. The interruption can in particular take place based on an actuation of the pedal arrangement and/or the comparison of set and actual quantity, for example on actuating a brake pedal.

### BRIEF DESCRIPTION OF THE DRAWINGS

The detailed description will hereinafter be presented in conjunction with the following drawing figures, wherein like numerals denote like elements, and:

FIG. 1 is a motor vehicle according to an embodiment; and

FIG. 2 is a method for the automatic actuating of a clutch of the motor vehicle of FIG. 1.

### DETAILED DESCRIPTION

The following detailed description is merely exemplary in nature and it is not intended to limit application and uses. Furthermore, there is no intention to be bound by any theory presented in the preceding background or summary or the following detailed description.

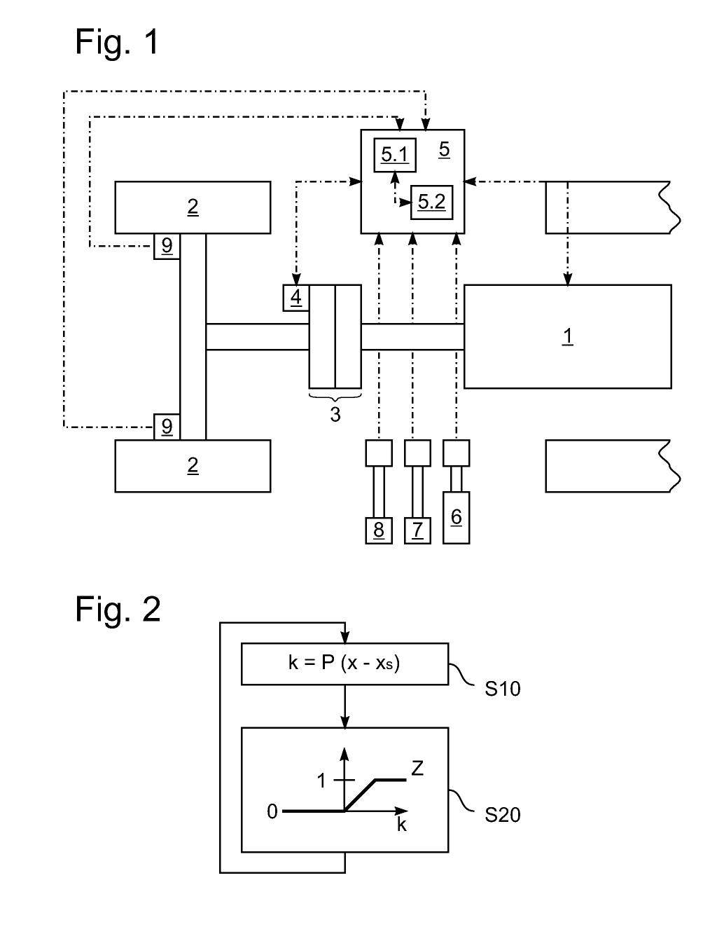

FIG. 1 shows a motor vehicle according to an embodiment with an internal combustion engine 1, a drive wheel arrangement 2 that can be connected to the former, a clutch 3 for the optional connecting and disconnecting of internal combustion engine 1 and drive wheel arrangement 2, an actuator 4 for actuating this clutch, and a controller 5 for controlling this actuator 4. This controller 5 comprises a comparator 5.1 for comparing a set quantity (x_{S}) and an actual quantity (x) (see FIG. 2) and an actuator 5.2 that is equipped based on this comparison (x−x_{S}) of set and actual quantity to in particular partly close or open the clutch 3. The controller 5 can for example be integrated or implemented in an ECU of the motor vehicle and be data or signal-connected via a bus system to the internal combustion engine 1, the actuator 4, wheel speed sensors 9 and an actuating travel sensor of an accelerator pedal 6, brake pedal 7 and clutch pedal 8, as is indicated in FIG. 1 in a dash-dotted manner

The clutch 3 is configured as an automatically actuatable clutch-by-wire clutch: when the driver actuates the clutch pedal 8, this is sensed by the controller 5 which actuates the clutch 3 with the actuator 4. In addition, the controller 5, particular its actuator 5.2, can also automatically actuate the clutch 3 with the actuator 4 according to a method according to an embodiment, which can be implement or embodied exemplarily through the controller 5, in particular its comparator 5.1 and actuator 5.2, and which is explained in the following with reference to FIG. 2:

In a step S10, the comparator means 5.1 compares a set quantity excess and an actual quantity x. This quantity is, for example, vehicle speed or vehicle acceleration. Here, a vehicle actual speed x can be determined based on the sensor signals of the wheel speed sensors 9, a vehicle actual acceleration x on the basis of a time differentiation of these sensor signals. A vehicle set speed or set acceleration x_{S} can in particular be determined based on an actuation of the pedal arrangement 6-8. In particular, a set acceleration=0 can be predetermined or determined when neither accelerator nor brake pedal 6, 7 are actuated.

In the embodiment, the actuator 5.2 comprises a proportional or differential controller that determines a control quantity k from a difference x−x_{S} multiplied with a proportionality constant p between actual and set value and from this determines an actuating quantity Z for the clutch 3 or its actuator 4 in a step S20. In the embodiment, as indicated in FIG. 2, this is equal to 0 for negative values k<0 and linearly rises from k up to 1 for positively increasing values. The actuating quantity Z∈[0, 1] in the embodiment constitutes a standardized clutch state, where Z=0 corresponds to a completely opened clutch 3, Z=1 to a completely closed clutch 3, and 0<Z<1 to a partly opened or closed clutch 3.

When the driver actuates neither accelerator nor brake pedal 6, 7, a set acceleration=0 or the wish for a constant vehicle speed is inferred from this. This request is compared with the actual state of the vehicle. If the vehicle travels with constant speed or if the vehicle becomes slower (x≦x_{S}), a control variable Z=0 is obtained and the actuator 5.2 completely opens the clutch 3 with the actuator 4, i.e., switches the vehicle or its clutch 3 into the sailing mode. In the sailing mode, no drag moment of the internal combustion engine 1 decoupled from the drive wheel arrangement 2 by way of the clutch brakes the free rolling of the vehicle. If the vehicle, by contrast becomes (unintentionally) faster, for example, when travelling down a steeper incline section, an actuating quantity 0<Z≦1 is obtained and the actuator 5.2 increasingly closes the clutch 3 with the actuator 4, in particular completely (Z=1), i.e., allows the clutch to slip or switches the vehicle into the deceleration mode, in which the control means 5 interrupts a fuel supply to the internal combustion engine 1. In this way, through the (increasing) drag moment of the internal combustion engine 1, the vehicle brakes and the desired constant vehicle speed thus obtained.

In particular with a slipping clutch 3 the latter can overheat. For this reason it can be provided that additionally or alternatively the actual temperature is compared with a set temperature and the clutch 3 is automatically completely opened (Z=0) or closed (Z=1) through the actuator 5.2 with the actuator 4 as soon as the actual temperature sufficiently exceeds the set temperature (limit). Additionally or alternatively to a determining of a set speed or set acceleration based on an actuation of the pedal arrangement, it can be provided according to an embodiment that upon an actuation of at least one pedal 6, 7 and 8 of the pedal arrangement, the clutch 3 is automatically completely closed (Z=1) through the actuator 5.2 with the actuator 4.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A motor vehicle,
an internal combustion engine;
a drive wheel arrangement connected to the internal combustion engine;
a clutch that is configured to connect and disconnect the internal combustion engine and the drive wheel arrangement;
an actuator that is configured to actuate the clutch; and
a controller that is configured to control the actuator, wherein the controller comprises:
a comparator that is configured to provide a comparison between a set (x_{S}) and an actual quantity (x); and
an actuator that is equipped based at least in part on the comparison between the set (x_{S}) and the actual quantity (x−x_{S}) to close and open the clutch.

2. The motor vehicle according to claim 1, wherein the comparator is configured to compare thermal quantities.

3. The motor vehicle according to claim 1, further comprising an estimator that is configured to estimate a kinematic quantity, in particular vehicle speed and/or vehicle acceleration,
wherein the actuator is configured to close or open the clutch based at least in part on the estimate of the kinematic quantity.

4. The motor vehicle according to claim 1, further comprising a pedal arrangement (6-8) with an accelerator pedal and a brake pedal,
wherein the actuator is configured to close or open the clutch based at least in part on an actuation of the pedal arrangement.

5. The motor vehicle according to claim 1, wherein the actuator or configured to continuously partly close or open.

6. The motor vehicle according to claim 1,
a fuel controller that is configured to interrupt a fuel supply of the internal combustion engine that is equipped in order to interrupt the fuel supply based at least in part on an actuation of a pedal arrangement with an accelerator pedal and a brake pedal.

7. The motor vehicle according to claim 1, wherein the actuator (5.2) is signal-connected electrically in a cable-free manner.

8. The motor vehicle according to claim 1, wherein the actuator is equipped in order to electromotorically actuate the clutch electromotorically.

9. A method for automatically actuating a clutch of a motor vehicle, comprising:
comparing a set quantity and an actual quantity (x−x_{S}); and
at least partially closing or opening of the clutch based on the comparing the set quantity and the actual quantity.

10. The method according to claim 9, further comprising:
comparing thermal quantities, dynamic quantities and kinematic quantities.

11. The method according to claim 9, further comprising:
estimating a kinematic quantity; and
at least partially closing or opening the clutch based at least in part on the estimating the kinematic quantity.

12. The method according to claim 9, further comprising at least partially closing or opening the clutch based at least in part on an actuation of a pedal arrangement with an accelerator pedal and a brake pedal.

13. The method according to claim 9, wherein the at least partially closing or opening of the clutch is a substantially continuous partial closing or opening of the clutch.

14. (canceled)

15. The motor vehicle according to claim 2, wherein the thermal parameters are clutch temperatures.

16. The motor vehicle according to claim 2, wherein the thermal parameters are dynamic quantities.
